(19) United States
(12) Patent Application Publication
(10) Pub. No.: US 2026/0050188 A1
(43) Pub. Date: Feb. 19, 2026

(54) POLARIZER AND DISPLAY DEVICE

(71) Applicant: TCL China Star Optoelectronics Technology Co., Ltd., ShenZhen (CN)

(72) Inventors: Yi FENG, ShenZhen (CN); Ji LI, ShenZhen (CN)

(73) Assignee: TCL China Star Optoelectronics Technology Co., Ltd., ShenZhen (CN)

(21) Appl. No.: 18/929,684

(22) Filed: Oct. 29, 2024

(30) Foreign Application Priority Data
Aug. 16, 2024 (CN) 202411125578.X

(51) Int. Cl. G02F 1/1335

(52) U.S. Cl. CPC G02F 1/133528

(57) ABSTRACT

The present application discloses a polarizer and a display device. The polarizer includes a polarization main layer and optical material dispersed in the polarization main layer; the optical material includes at least one of an absorption function, a reflection function, and a wavelength conversion function to light in a first predetermined wavelength range. A light transmittance of the light in the first predetermined wavelength range on the polarizer is less than a light transmittance of light in a second predetermined wavelength range on the polarizer. The first predetermined wavelength range does not overlap and the second predetermined wavelength range, and a thermal effect of the light in the first predetermined wavelength range is greater than a thermal effect of the light in the second predetermined wavelength range.

### RELATED APPLICATIONS

This application is a Paris Convention Patent Application, which claims the benefit of priority of Chinese Patent Application No. 202411125578.X, filed on Aug. 16, 2024. The contents of the above application is all incorporated by reference as if fully set forth herein in its entirety.

### FIELD AND BACKGROUND OF THE INVENTION

The present application relates to a field of display technologies, especially to a polarizer and a display device.

In the electromagnetic spectrum, radiation located beyond red light, with a frequency lower than visible light but higher than microwaves, is called infrared. Infrared cannot be seen by the naked eye and is not part of visible light. Infrared, also known as infrared thermal radiation, has a strong thermal effect. Infrared can resonate with most inorganic molecules and large organic molecules within biological organisms, causing these molecules to accelerate their motion and rub against each other, producing heat. Therefore, infrared can be used for heating.

In a liquid crystal display device (LCD), the commonly used backlight consists of a blue light-emitting diode (LED) and a color conversion material. The color conversion material includes yellow fluorescent powder, red fluorescent powder, red quantum dots, green quantum dots, and other materials. The blue light emitted by the LED excites the color conversion material to emit light of other colors, which are then mixed to form white light. The color conversion material includes both inorganic and organic color conversion materials. Due to the presence of lattice defects in inorganic color conversion materials and vibrational energy levels in organic color conversion materials, infrared light with a longer wavelength and lower energy is emitted during the color conversion process. Since infrared light is outside the range observable by the human eye, it does not affect the color performance of the display device and is often ignored. However, when the display screen is lit for a long period, the infrared emitted by the backlight continuously heats the display screen, causing the temperature of the display screen to rise. Temperature has a harmful effect on materials in the display screen, such as liquid crystal, color resist, or frame sealant. Heating of these materials in a long period accelerates their aging, thereby affecting the lifespan of the display screen.

### SUMMARY OF THE INVENTION

The present application provides a polarizer and a display device that can effectively reduce a light transmittance of light in a first predetermined wavelength range with a greater thermal effect in a polarizer, thereby effectively improving a use lifespan of the display product applied with the polarizer.

The present application provides a polarizer, comprising a polarization main layer and optical material dispersed in the polarization main layer, wherein the optical material comprises at least one of an absorption function, a reflection function, and a wavelength conversion function to light in a first predetermined wavelength range;

wherein a light transmittance of light in the first predetermined wavelength range on the polarizer is less than a light transmittance of light in a second predetermined wavelength range on the polarizer, the first predetermined wavelength range does not overlap the second predetermined wavelength range, and a thermal effect of the light in the first predetermined wavelength range is greater than a thermal effect of the light in the second predetermined wavelength range.

Optionally, the first predetermined wavelength range ranges from 800 nanometers to 1100 nanometers, and the second predetermined wavelength range ranges from 400 nanometers to 650 nanometers.

Optionally, the light transmittance of the light in the first predetermined wavelength range on the polarizer is less than 40%, and the light transmittance of the light in the second predetermined wavelength range on the polarizer is greater than 80%.

Optionally, the polarization main layer comprises a first adhesive layer, a polarization function layer, and a substrate layer; the first adhesive layer is located on a side of the polarization function layer, and the substrate layer is located on a side of the polarization function layer away from the first adhesive layer; and
the optical material is dispersed in one or more of the first adhesive layer, the polarization function layer, and the substrate layer.

Optionally, the polarization main layer comprises a first adhesive layer, a polarization function layer, and a substrate layer; the first adhesive layer is located on a side of the polarization function layer, and the substrate layer is located on a side of the polarization function layer away from the first adhesive layer; and
the optical material is dispersed in the first adhesive layer and/or the substrate layer.

Optionally, the substrate layer comprises a first sub-substrate layer, a second adhesive layer, and a second sub-substrate layer stacked on the polarization function layer; and
the optical material is dispersed in one or more of the first adhesive layer, the first sub-substrate layer, the second adhesive layer, and the second sub-substrate layer.

Optionally, the optical material comprises an absorption function to the light in the first predetermined wavelength range; the optical material is selected from at least one of silicon-substituted xanthene organic matter and triarylmethane dye; and/or
the optical material is selected from nanometer oxide particles, material of the nanometer oxide particles comprises at least one of magnesium oxide, zinc oxide, and titanium dioxide.

Optionally, the polarization main layer comprises at least one film layer with the optical material dispersed in the film layer, and a mass percentage of the optical material in the film layer ranges from 1% to 5%.

The present application further provides a display device, comprising a display module, a backlight module, and the above polarizer, wherein the backlight module is located on a side of the display module, and the polarizer is at least located on a side of the display module facing the backlight module.

Optionally, the polarizer is further disposed on a side of the display module away from the backlight module.

The polarizer and the display device provided by the present application, by adding the optical material in the polarization main layer of the polarizer in which the optical material has at least one of an absorption function, a reflection function, and a wavelength conversion function to the light in the first predetermined wavelength range (for example, near-infrared light) with the greater thermal effect, can effectively reduce the light transmittance of the light in the first predetermined wavelength range with the greater thermal effect in the polarizer. The polarizer, when applied in the display device, can effectively prevent the light in the first predetermined wavelength range with the greater thermal effect (for example, near-infrared light) in the backlight and/or ambient light from entering the display module of the display device, thereby being able to prevent a lowered lifespan the display module of due to thermal effect. Therefore, the embodiment of the present application can effectively improve the use lifespan of the display product applied with the polarizer of the present application.

### BRIEF DESCRIPTION OF THE SEVERAL VIEWS OF THE DRAWING(S)

Specific embodiments of the present invention are described in details with accompanying drawings as follows to make technical solutions and advantages of the present invention clear.

FIG. 1 is a schematic structural view of a polarizer provided by the embodiment of the present application.

FIG. 2 is a schematic structural view of another polarizer provided by the embodiment of the present application.

FIG. 3 is a schematic structural view of another polarizer provided by the embodiment of the present application.

FIG. 4 is a schematic structural view of another polarizer provided by the embodiment of the present application.

FIG. 5 is a schematic structural view of another polarizer provided by the embodiment of the present application.

FIG. 6 is a schematic structural view of another polarizer provided by the embodiment of the present application.

FIG. 7 is a schematic view of light transmission of a selected film layer provided by the embodiment of the present application.

FIG. 8 is an absorption spectrum diagram of three of optical material provided by the embodiment of the present application.

FIG. 9 is a schematic structural view of a display device provided by the embodiment of the present application.

### DESCRIPTION OF SPECIFIC EMBODIMENTS OF THE INVENTION

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application.

In the description of the present application, it should be understood that terminologies of “center”, “longitudinal”, “transverse”, “length”, “width”, “thickness”, “upper”, “lower”, “front”, “rear”, “left”, “side”, “vertical”, “horizontal”, “top”, “bottom”, “inner”, “outer”, “clockwise”, “counterclockwise” for indicating relations of orientation or position are based on orientation or position of the accompanying drawings, are only for the purposes of facilitating description of the present application and simplifying the description instead of indicating or implying that the referred device or element must have a specific orientation or position, must to be structured and operated with the specific orientation or position. Therefore, they should not be understood as limitations to the present application. Furthermore, terminologies “first”, “second” are only for the purposes of description, and cannot be understood as indication or implication of comparative importance or a number of technical features. Therefore, a feature limited with “first”, “second” can expressly or implicitly include one or more features. In the description of the present application, a meaning of “a plurality of” is two or more, unless there is a clear and specific limitation otherwise.

In the present application, it should be noted that unless clear rules and limitations otherwise exist, words “a first feature is “on” or “under” a second feature” can include a direct contact of the first and second features, can also include a contact of the first and second features through another feature therebetween instead of a direct contact. Furthermore, words “the first feature is “above” or “over” the second feature include that the first feature is right above or obliquely above the second feature, or only indicate that a level of the first feature is higher that of the second feature. Words “the first feature is “under” or “below” the second feature include that the first feature is right under or obliquely under the second feature, or only indicate that the level of the first feature is lower than that of the second feature.

The following disclosure provides many different embodiments or examples to achieve different structures of the present application. To simplify the disclosure of the present application, the components and arrangements of the specific examples are described below. Of course, they are merely examples, and the purpose is not to limit the present application. Furthermore, the present application may repeat reference numerals and/or reference letters in different examples. The repetition is for the purpose of simplification and clarity, and does not by itself indicate the relationship between the various embodiments and/or settings discussed. In addition, the present application provides examples of various specific processes and materials, but a person of ordinary skill in the art can be aware of the application of other processes and/or the use of other materials.

A normal LCD display device comprises, from bottom to top, a backlight module, a lower polarizer, a display panel (or a display module), and an upper polarizer. Because backlight emitted from the backlight module to the display panel comprises infrared light (for example, near-infrared light). When the display panel is lit for a long period, the infrared light in the backlight continuously heats the display panel, thereby resulting in the raised temperature of the display panel and accelerating aging of material such as liquid crystal, color resist, or frame sealant in the display panel such that the lifespan of the display panel is drastically reduced.

The inventor, after researching, has discovered that the lower polarizer is located between the backlight module and the display panel, and is optical function material laminated by multiple thin film layers. Also, the optical material having an absorption function, a reflection function, or a wavelength conversion to light in a specific wavelength range with a higher thermal effect (for example, near-infrared light) can be added in these thin films easier such that the formed polarizer can reduce a light transmittance of the light with the high thermal effect, thereby preventing the light of the high thermal effect emitted by the backlight module from entering the display panel. Thus, the present application provides a polarizer and a display device applied with the polarizer that can effectively reduce the light of the high thermal effect entering the display panel without increasing thicknesses and of the polarizer and the display device and processes of the polarizer and the display device, thereby being able to effectively improve a use lifespan of the display panel.

The present application will be described in detail by the following embodiments.

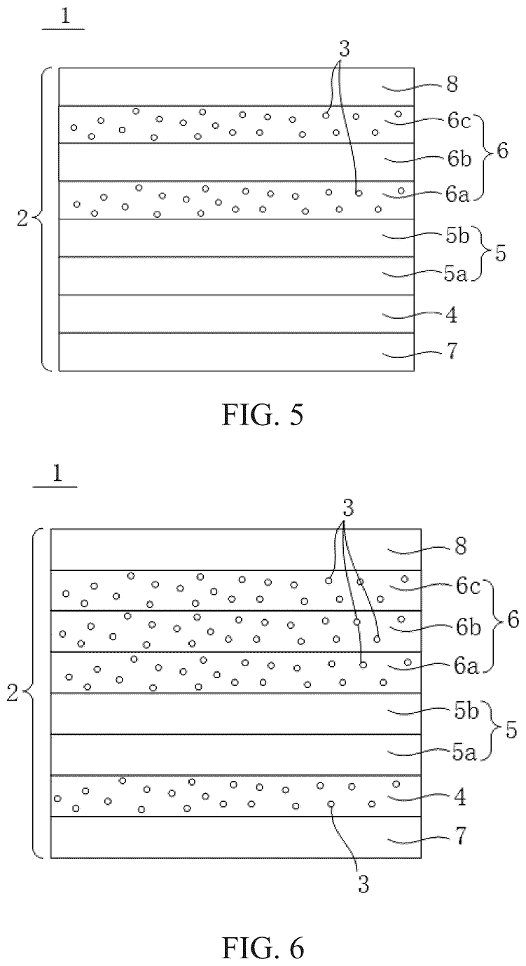

With reference to FIG. 1 to FIG. 6, the embodiment of the present application provides a polarizer 1. The polarizer 1 comprises a polarization main layer 2 and optical material 3 dispersed in the polarization main layer 2. The polarization main layer 2 allows polarized light along the predetermined direction to pass therethrough. The optical material 3 has at least one of an absorption function, a reflection function, and a wavelength conversion (namely, color conversion) to light in a first predetermined wavelength range. A light transmittance of the light in the first predetermined wavelength range on the polarizer 1 is less than a light transmittance of light in a second predetermined wavelength range on the polarizer 1. The first predetermined wavelength range does not overlap the second predetermined wavelength range, and a thermal effect of the light of the first predetermined wavelength range is greater than a thermal effect of the light in the second predetermined wavelength range.

In particular, the polarization main layer 2 allows polarized light along a predetermined direction to pass therethrough, thereby being able to convert disordered light along the polarization direction into linearly polarized light to achieve polarization function.

It can be comprehended that the optical material 3 is added in the polarization main layer 2 of the polarizer 1, and the optical material 3 has at least one of an absorption function, a reflection function, and a wavelength conversion function to the light in the first predetermined wavelength range with the greater thermal effect such that the light in the first predetermined wavelength range, when irradiated on the polarizer 1, can be at least partially absorbed, reflected, or color-converted, thereby being able to effectively reduce the light transmittance of the light in the first predetermined wavelength range on the polarizer 1.

In a specific embodiment, an absorption rate of the optical material 3 to the light in the first predetermined wavelength range is far greater than an absorption rate of the optical material 3 to the light in the second predetermined wavelength range, thereby being able to effectively reduce the light transmittance of the light in the first predetermined wavelength range without affecting the light transmittance of the light in the second predetermined wavelength range. Namely, the optical material 3 is material having a strong absorption function to the light in the first predetermined wavelength range.

Of course, in another embodiment, the optical material 3 can be material having a strong reflection effect to the light in the first predetermined wavelength range. Alternatively, the optical material 3 can be material having a color conversion effect to the light in the first predetermined wavelength range, and the optical material 3 can convert the light in the first predetermined wavelength range into light with a lower thermal effect.

In some embodiments, the first predetermined wavelength range ranges from 800 nanometers to 1100 nanometers, and the second predetermined wavelength range ranges from 400 nanometers to 650 nanometers. Namely, the light in the first predetermined wavelength range is near-infrared light, and the light in the second predetermined wavelength range is visible light. It can be comprehended that near-infrared light belongs to one of infrared light (also called infrared).

It should be explained that the embodiment of the present application has no limit to the first predetermined wavelength range, and any light having a strong thermal effect and able to accelerate aging of the material of the display module (for example, display panel or display screen) and the corresponding optical material 3 are within the protection range of the present application. Because infrared light emitted from the backlight module in the display device is usually near-infrared light, it can be targeted to add the optical material 3 configured to lower the light transmittance of the near-infrared light into the polarizer 1 applied in the display device.

In a specific embodiment, the light transmittance of the light in the first predetermined wavelength range on the polarizer 1 is less than 40%, and the light transmittance in light in the second predetermined wavelength range on the polarizer 1 is greater than 80%.

In other words, a light transmittance of visible light on the polarizer 1 is greater than 80%, and is basically not influenced by the optical material 3. Because of the absorption, reflection, or color conversion function of the optical material 3, light transmittance of the near-infrared light on the polarizer 1 is less than 40%. Adjusting a type and a distribution range of the optical material 3 can further adjust the light transmittance of the near-infrared light.

Therefore, the polarizer 1 provided by the embodiment of the present application can effectively lower the light transmittance of the near-infrared light without affecting a light transmittance of the visible light. The polarizer 1, when applied to a display device, can effectively prevent near-infrared light in the backlight or the ambient light from entering the display module of the display device, thereby being able to prevent a lowered lifespan of the display module due to the thermal effect of the near-infrared light.

In some embodiments, with reference to FIG. 1 to FIG. 3, the polarization main layer 2 comprises a first adhesive layer 4, a polarization function layer 5 and a substrate layer 6. The first adhesive layer 4 is located on a side of the polarization function layer 5. The substrate layer 6 is located on a side of the polarization function layer 5 away from the first adhesive layer 4.

In particular, the optical material 3 is dispersed in the first adhesive layer 4, especially in one or more of the polarization function layer 5 and the substrate layer 6.

In particular, the first adhesive layer 4 is configured to fix the polarization function layer 5 on the target display product, and material of the first adhesive layer 4 comprises pressure sensitive adhesive (PSA), but no limit is thereto.

In some embodiments, the polarization function layer 5 comprises a compensation layer 5a and a polarization layer 5b. The first adhesive layer 4 is located on a side of the compensation layer 5a away from the polarization layer 5b. The polarization layer 5b is located between the compensation layer 5a and the substrate layer 6.

In a specific embodiment, material of the polarization layer 5b comprises polyvinyl alcohol (PVA), but no limit is thereto.

In some embodiments, material of the substrate layer 6 comprises organic polymer such as polyethylene terephthalate (PET) or polymethyl methacrylate (, PMMA), but no limit is thereto.

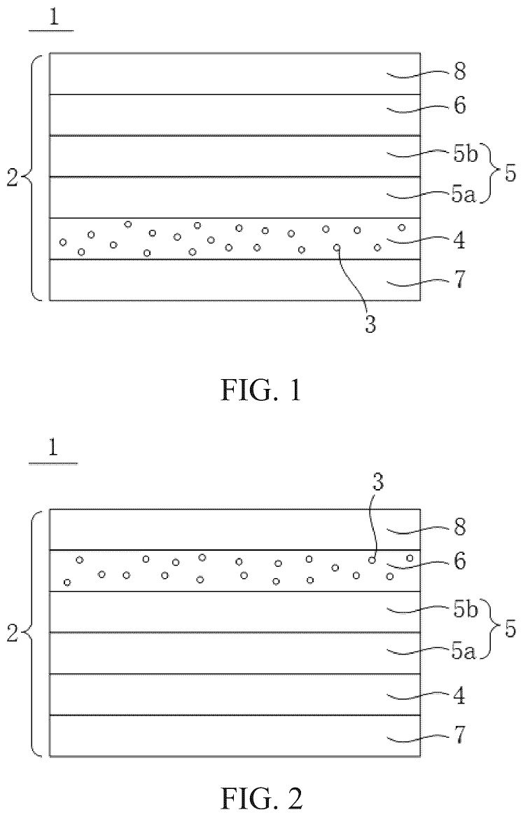

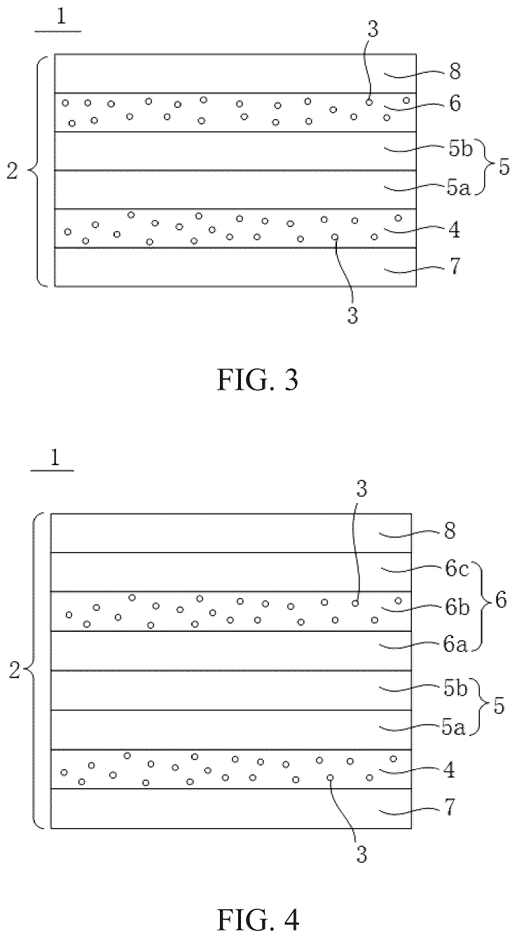

In a specific embodiment, the optical material 3 is dispersed in the first adhesive layer 4 and/or the substrate layer 6. Namely, with reference to FIG. 1, the optical material 3 is only dispersed in the first adhesive layer 4. Alternatively, with reference to FIG. 2, the optical material 3 is only dispersed in the substrate layer 6. Alternatively, with reference to FIG. 3, the optical material 3 is dispersed in the first adhesive layer 4 and the substrate layer 6.

It can be comprehended that the greater a quantity of the film layers dispersed with the optical material 3 is, the better the lower effect to the light transmittance of the light in the first predetermined wavelength range is, and the better the light transmittance of the light in the first predetermined wavelength range on the polarizer 1 is reduced.

Because material of both the first adhesive layer 4 and the substrate layer 6 is organic material, these layers can be manufactured by the stretching film formation or film coating process. Thus, during the manufacturing process, the optical material 3 can be easily added. For example, when the substrate layer 6 is manufactured by the stretching film formation process, the powder optical material 3 can be directly added in resin material to manufacture slices, and then the substrate layer 6 containing the optical material 3 is formed by melting, extrusion, stretching processes. When the first adhesive layer 4 is manufactured by using the film coating process, the optical material 3, resin, solvent, and curing agent can be mixed to form a coating liquid, and then the first adhesive layer 4 containing the optical material 3 is formed by processes such as coating process and heat drying process.

Also, to prevent a risk of the lowered polarization effect and compensation effect resulting from the optical material 3 added in the compensation layer 5a and the polarization function layer 5 such as the polarization layer 5b, the optical material 3 is preferably added in the first adhesive layer 4 and/or the substrate layer 6, thereby being able to reduce the light transmittance of the light in the first predetermined wavelength range on the basis of guaranteeing the normal polarization function of the polarizer 1.

In some embodiments, with reference to FIG. 4 to FIG. 6, the substrate layer 6 comprises a first sub-the substrate layer 6a, a second adhesive layer 6b, and a second sub-the substrate layer 6c stacked on the polarization function layer 5. The optical material 3 is dispersed in one or more of the first adhesive layer 4, the first sub-the substrate layer 6a, the second adhesive layer 6b, and the second sub-the substrate layer 6c.

It can be comprehended that material and manufacturing method for the first sub-the substrate layer 6a, the second sub-the substrate layer 6c can be the same as those for the above the substrate layer 6, but no limit is thereto. Material and manufacturing method for the second adhesive layer 6b and the first adhesive layer 4 can be the same, but no limit is thereto.

For convenience of description, the embodiment of the present application calls the film layer added with the optical material 3 in the polarizer 1 as a selected film layer. It can be comprehended that the selected film layer is an original film layer (for example, the substrate layer 6 and/or the first adhesive layer 4) in the polarizer 1 without additional configuration, and therefore would not change the thickness of the polarizer 1. Also, a quantity of the selected film layer is one or more.

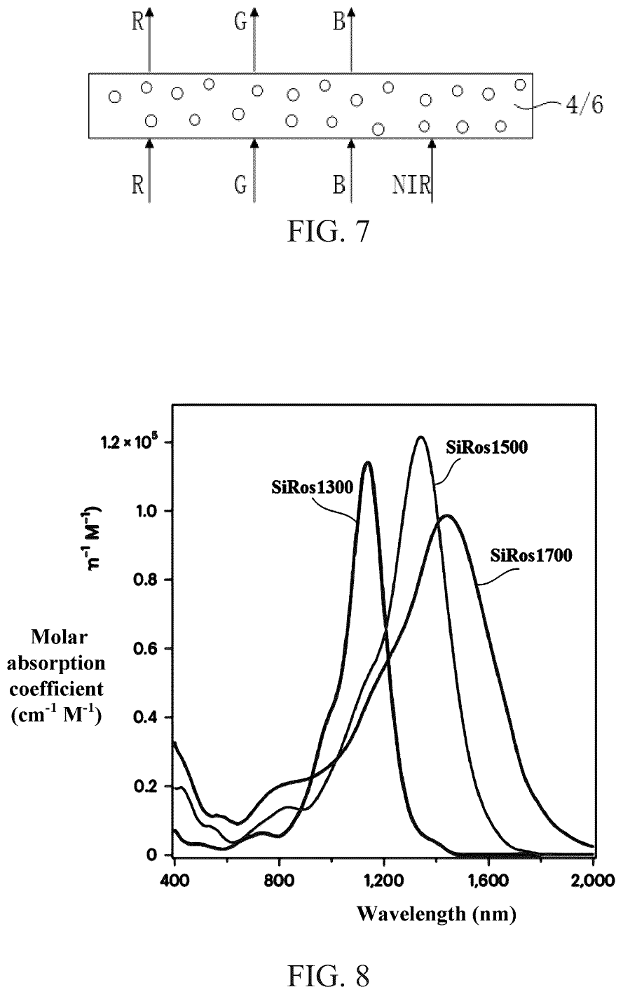

The optical material 3 added in the selected film layer being infrared light absorption material is used as an example, with reference to FIG. 7, when light is irradiated to a side of the selected film layer (for example, the substrate layer 6 and/or the first adhesive layer 4), incident light comprises red light (R), green light (G), blue light (B), and near-infrared light (NIR). Because the optical absorbent has a stronger absorption function to the near-infrared light, light pass through another side of the selected film layer is red light (R), green light (G), and blue light (B). The red light (R), green light (G), and blue light (B) are visible light.

Of course, according to different types, distribution densities, and distribution ranges of the optical material 3, the light transmittance of the near-infrared light on the selected film layer is different. When the near-infrared light can partially pass through the selected film layer, an amount of the transmitted near-infrared light is far less than an amount of the near-infrared light in the incident light.

Therefore, the selected film layer added with the optical material 3 comprises an absorption function, a reflection function, or a color conversion function to infrared light such that the polarizer 1 has a function of lowering the light transmittance of the infrared light.

In particular, a method for manufacturing the selected film layer added with the optical material 3 comprises a stretching film formation method and a coating film formation method, but no limit is thereto.

In some embodiments, steps of manufacturing a selected film layer added with optical material by the stretching film formation method are as follows:
adding polymer (resin) particles in powder optical material and agitating and mixing the polymer (resin) particles and the powder optical material;
adding mixed material into a film formation feeding system, and heat-melting the mixed material; and
extruding and stretching the mixed material for film formation, and forming a selected film layer added with the optical material.

In some embodiments, a thickness of the selected film layer manufactured by the stretching film formation process ranges from 20 microns to 80 microns, and a mass percentage of the optical material in the selected film layer ranges from 1% to 5%. The mass percentage of the optical material set within such range would not influence the light transmittance of the visible light.

In a specific embodiment, a mass percentage of the optical material in the selected film layer ranges from 1%, 2%, 3%, 4% or 5%.

In some embodiments, steps of a coating film formation method for manufacturing the selected film layer added with optical material are as follows:
mixing optical material in resin material, adding ethyl acetate in the material and fully agitating the material to form a mixture solution;
adding a thermal curing additive in the mixture solution to form a coating liquid; and
forming a coating film formation on a substrate by the coating liquid, and removing a solvent by a heat drying process to make the resin material further cross-link to form a selected film layer added with the optical material.

In some embodiments, a thickness of the selected film layer manufactured by the film coating process ranges from 10 microns to 40 microns. Before coating, a solid content of glue in the coating liquid ranges from 5% to 25%, and preferably is 15%, and a mass percentage of the optical material in the solid content ranges from 1% to 5%. Namely, the mass percentage of the optical material in the coated selected film layer ranges from 1% to 5%. The mass percentage of the optical material set within this range would not influence the light transmittance of the visible light.

In a specific embodiment, the solid content of the glue in the coating liquid is 5%, 10%, 15%, 20% or 25%, and the mass percentage of the optical material in the solid content is 1%, 2%, 3%, 4% or 5%.

In particular, the selected film layer manufactured by any one of the above manufacturing methods and another film layer cooperatively constitute the polarizer 1.

In some embodiments, the substrate layer 6 is manufactured by the stretching film formation process, and the first adhesive layer 4 and the second adhesive layer 6b are manufactured by the film coating process, but no limit is thereto. During manufacturing the first adhesive layer 4, the above substrate can be a stacked structure of a base substrate and the polarization function layer 5, but no limit is thereto.

In some embodiments, the optical material 3 has an absorption function to the light in the first predetermined wavelength range (for example, near-infrared light). In a specific embodiment, the optical material 3 is selected from at least one of silicon-substituted xanthene organic matter and triarylmethane dye. Such organic matter has a lower absorbance in the visible light region, and has a higher absorbance in the near-infrared region, thereby being able to serve as a near-infrared light absorbing material.

In a specific embodiment, the silicon-substituted xanthene organic matter comprises a silicon-rosindolizine (SiRos) group. For example, the silicon-substituted xanthene organic matter comprises at least one of SiRos1300, SiRos1550, and SiRos1700, and a chemical structural formula of the silicon-substituted xanthene organic matter is as follows:

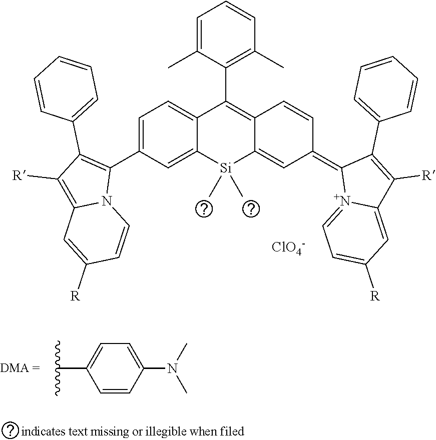

An R group and a R′ group of SiRos1300 are selected from hydrogen (H) atoms; an R group of SiRos1550 is selected from DMA groups, and a R′ group thereof is selected from C₈H₁₇; an R group and a R′ group of SiRos1700 are selected from DMA groups.

In particular, an absorption spectrum diagram of SiRos1300, SiRos1550, and SiRos1700 is as shown in FIG. 8. It can be understood from FIG. 8 that the absorbance of SiRos1300, SiRos1550, and SiRos1700 in the near-infrared light region is drastically greater than the absorbance in the visible light region.

Therefore, one or mixture of more than one of SiRos1300, SiRos1550, and SiRos1700 can serve as the optical material 3 of the embodiment of the present application.

In another some embodiments, the optical material 3 is selected from nanometer oxide particles. Material of the nanometer oxide particles comprises at least one of magnesium oxide, zinc oxide, and titanium dioxide. Such nanometer oxide particles have a lower absorbance in the visible light region, have a higher absorbance in the near-infrared region, and can serve as near-infrared light material.

In some embodiments, a particle diameter of the nanometer oxide particles ranges from 10 nanometers to 1000 nanometers. In a specific embodiment, the particle diameter of the nanometer oxide particles is 10 nanometers, 20 nanometers, 50 nanometers, 100 nanometers, 300 nanometers, 500 nanometers, 800 nanometers, or 1000 nanometers.

In some embodiments, the optical material 3 is added in the multiple selected film layers in the polarization main layer 2, and the optical material 3 added in each of the selected film layers is the same.

In another some embodiments, the optical material 3 is added in the multiple selected film layers in the polarization main layer 2, and the optical material 3 in at least two of the selected film layers is different.

In some embodiments, only one of the selected film layers in the polarization main layer 2 is added with the optical material 3, and the optical material 3 in the selected film layer can be selected from the same or different material.

It can be comprehended that the optical material 3 in the embodiment of the present application can be selected from the same material, can be selected from different material, and the optical material 3 of the different material can be different material in organic material or different material in inorganic material, and also can be mixed material of organic material and inorganic material.

In particular, when the optical material 3 is inorganic material or organic material with high heat resistance, the above stretching film formation process can be utilized to manufacture the selected film layer. When the optical material 3 is organic material, the above film coating process can be utilized to manufacture the selected film layer.

Of course, inorganic material can also be evenly dispersed by auxiliary organic dispersion resin in an ethyl acetate solution, and form the selected film layer by the film coating process. For example, inorganic material is evenly dispersed in an ethyl acetate solution containing PSA by auxiliary organic dispersion resin, and forms the first adhesive layer 4 or the second adhesive layer 6b by the film coating process.

In some embodiments, with reference to FIG. 1 to FIG. 6, the polarizer 1 further comprises a release film 7 located on a side of the first adhesive layer 4 away from the polarization function layer 5 and a protection layer 8 located on a side of the substrate layer 6 away from the polarization function layer 5. Because the release film 7 and the protection layer 8 would be removed when the polarizer 1 is applied in a display device 10, no optical material 3 is needed to be added in the release film 7 and the protection layer 8 of the polarizer 1.

Of course, the structure of the polarizer 1 provided by the embodiment of the present application is not limited. The polarizer 1 can also comprise at least one additional optical film layer. To prevent a negative effect on the additional optical film layer, the optical material 3 is not added in the additional optical film layer.

In the embodiment of the present application, by adding the optical material 3 in the polarization main layer 2 of the polarizer 1 in which the optical material 3 has at least one of an absorption function, a reflection function, and a wavelength conversion function to the light in the first predetermined wavelength range (for example, near-infrared light) with the greater thermal effect, the light transmittance of the light in the first predetermined wavelength range with the greater thermal effect in the polarizer 1 can be effectively reduced. The polarizer 1, when applied in the display device, can effectively prevent the light in the first predetermined wavelength range with the greater thermal effect (for example, near-infrared light) in the backlight and/or ambient light from entering the display module of the display device, thereby being able to prevent a lowered lifespan the display module of due to thermal effect. Therefore, the embodiment of the present application can effectively improve the use lifespan of the display product applied with the polarizer 1 of the present application.

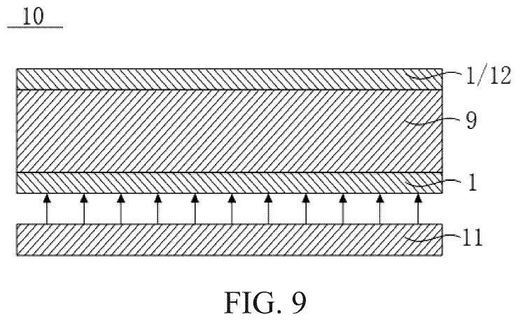

With reference to FIG. 9, the embodiment of the present application further provides a display device 10, the display device 10 comprises a display module 9, a backlight module 11, and the polarizer 1 of the above embodiment. The backlight module 11 is located on a side of the display module 9. The polarizer 1 is at least on a side of the display module 9 facing the backlight module 11.

In some embodiments, the polarizer 1 is located between the display module 9 and the backlight module 11 as a lower polarizer. Also, the display device 10 further comprises an upper polarizer 12located on a side of the display module 9 away from the backlight module 11, and the upper polarizer 12 does not comprise the optical material 3 provided by the embodiment of the present application. At this time, the polarizer 1 serves as the lower polarizer and can effectively absorb near-infrared light emitted by the backlight module 11 to prevent a large amount of the near-infrared light from entering the display module 9, thereby preventing the near-infrared light from having a thermal effect to and aging material in the display module 9 to further improve the use lifespan of the display module 9.

In another some embodiments, the polarizer 1 is located between the display module 9 and the backlight module 11 and serves as the lower polarizer. Also, the polarizer 1 is located on a side of the display module 9 away from the backlight module 11 and serves as an upper polarizer. It can be comprehended that the polarized light allowed to pass through the upper polarizer and the polarized light allowed to pass through the lower polarizer can be the same and can be perpendicular to each other, and no limit is here. The polarizer 1 added with the optical material 3 is disposed between the display module 9 and the backlight module 11 to be able to effectively reduce or prevent the near-infrared light emitted by the backlight module 11 from entering the display module 9. Also, the polarizer 1 added with the optical material 3 is disposed on a side of the display module 9 away from the backlight module 11 and can effectively reduce or prevent the near-infrared light in the ambient light from entering the display module 9, thereby more effectively improving the use lifespan of the display module 9.

In some embodiments, the display module 9 is but not limited to a liquid crystal display panel.

In some embodiments, the backlight module 11 comprises an LED light source and a color conversion layer. a monochromatic light emitted by the LED light source excites the color conversion layer to emit light of another color, and mix the light of the two colors into white light.

It can be comprehended that the embodiment of the present application has no limit to the structures of the backlight module 11 and the display module 9. The above structures of the display module 9 and the backlight module 11 are only for an example of descriptions.

In the embodiment of the present application, because the polarizer 1 added with the optical material 3 has the function of reducing the light transmittance of the near-infrared light, the polarizer 1 can effectively prevent near-infrared light in backlight and/or ambient light from entering the display module 9, thereby being able to prevent the lowered lifespan of the display module 9 due to the thermal effect. Thus, the embodiment of the present application can effectively improve the use lifespan of the display device 10.

In the above-mentioned embodiments, the descriptions of the various embodiments are focused. For the details of the embodiments not described, reference may be made to the related descriptions of the other embodiments.

The polarizer and the display device provided by the embodiment of the present application are described in detail as above. In the present specification, principles and embodiments of the present application are described using specific examples. The explanation of the above embodiments is only intended to assist in understanding the core ideas of the present application. It should be noted that for those skilled in the art in this technical field, various improvements and modifications can be made to the present application without departing from the principles of the present application. These improvements and modifications also fall within the scope of the claims of the present application.

1. A polarizer, comprising a polarization main layer and optical material dispersed in the polarization main layer, wherein the optical material comprises at least one of an absorption function, a reflection function, and a wavelength conversion function to light in a first predetermined wavelength range;
wherein a light transmittance of light in the first predetermined wavelength range on the polarizer is less than a light transmittance of light in a second predetermined wavelength range on the polarizer, the first predetermined wavelength range does not overlap the second predetermined wavelength range, and a thermal effect of the light in the first predetermined wavelength range is greater than a thermal effect of the light in the second predetermined wavelength range.

2. The polarizer according to claim 1, wherein the first predetermined wavelength range ranges from 800 nanometers to 1100 nanometers, and the second predetermined wavelength range ranges from 400 nanometers to 650 nanometers.

3. The polarizer according to claim 1, wherein the light transmittance of the light in the first predetermined wavelength range on the polarizer is less than 40%, and the light transmittance of the light in the second predetermined wavelength range on the polarizer is greater than 80%.

4. The polarizer according to claim 1, wherein
the polarization main layer comprises a first adhesive layer, a polarization function layer, and a substrate layer; the first adhesive layer is located on a side of the polarization function layer, and the substrate layer is located on a side of the polarization function layer away from the first adhesive layer; and
the optical material is dispersed in one or more of the first adhesive layer, the polarization function layer, and the substrate layer.

5. The polarizer according to claim 1, wherein
the polarization main layer comprises a first adhesive layer, a polarization function layer, and a substrate layer; the first adhesive layer is located on a side of the polarization function layer, and the substrate layer is located on a side of the polarization function layer away from the first adhesive layer; and
the optical material is dispersed in the first adhesive layer and/or the substrate layer.

6. The polarizer according to claim 5, wherein
the substrate layer comprises a first sub-substrate layer, a second adhesive layer, and a second sub-substrate layer stacked on the polarization function layer; and
the optical material is dispersed in one or more of the first adhesive layer, the first sub-substrate layer, the second adhesive layer, and the second sub-substrate layer.

7. The polarizer according to claim 1, wherein
the optical material comprises an absorption function to the light in the first predetermined wavelength range; the optical material is selected from at least one of silicon-substituted xanthene organic matter and triarylmethane dye; and/or
the optical material is selected from nanometer oxide particles, material of the nanometer oxide particles comprises at least one of magnesium oxide, zinc oxide, and titanium dioxide.

8. The polarizer according to claim 1, wherein the polarization main layer comprises at least one film layer with the optical material dispersed in the film layer, and a mass percentage of the optical material in the film layer ranges from 1% to 5%.

9. A display device, comprising a display module, a backlight module, and a polarizer, wherein the backlight module is located on a side of the display module, and the polarizer is at least located on a side of the display module facing the backlight module and comprises a polarization main layer and optical material dispersed in the polarization main layer, wherein the optical material comprises at least one of an absorption function, a reflection function, and a wavelength conversion function to light in a first predetermined wavelength range;
wherein a light transmittance of light in the first predetermined wavelength range on the polarizer is less than a light transmittance of light in a second predetermined wavelength range on the polarizer, the first predetermined wavelength range does not overlap the second predetermined wavelength range, and a thermal effect of the light in the first predetermined wavelength range is greater than a thermal effect of the light in the second predetermined wavelength range.

10. The display device according to claim 9, wherein the polarizer is further disposed on a side of the display module away from the backlight module.

11. The polarizer according to claim 9, wherein the first predetermined wavelength range ranges from 800 nanometers to 1100 nanometers, and the second predetermined wavelength range ranges from 400 nanometers to 650 nanometers.

12. The polarizer according to claim 9, wherein the light transmittance of the light in the first predetermined wavelength range on the polarizer is less than 40%, and the light transmittance of the light in the second predetermined wavelength range on the polarizer is greater than 80%.

13. The polarizer according to claim 9, wherein
the polarization main layer comprises a first adhesive layer, a polarization function layer, and a substrate layer; the first adhesive layer is located on a side of the polarization function layer, and the substrate layer is located on a side of the polarization function layer away from the first adhesive layer; and
the optical material is dispersed in one or more of the first adhesive layer, the polarization function layer, and the substrate layer.

14. The polarizer according to claim 9, wherein
the polarization main layer comprises a first adhesive layer, a polarization function layer, and a substrate layer; the first adhesive layer is located on a side of the polarization function layer, and the substrate layer is located on a side of the polarization function layer away from the first adhesive layer; and
the optical material is dispersed in the first adhesive layer and/or the substrate layer.

15. The polarizer according to claim 14, wherein
the substrate layer comprises a first sub-substrate layer, a second adhesive layer, and a second sub-substrate layer stacked on the polarization function layer; and
the optical material is dispersed in one or more of the first adhesive layer, the first sub-substrate layer, the second adhesive layer, and the second sub-substrate layer.

16. A polarizer, comprising a polarization main layer and optical material dispersed in the polarization main layer, wherein the optical material comprises at least one of an absorption function, a reflection function, and a wavelength conversion function to light in a first predetermined wavelength range;
wherein a light transmittance of light in the first predetermined wavelength range on the polarizer is less than a light transmittance of light in a second predetermined wavelength range on the polarizer, the first predetermined wavelength range does not overlap the second predetermined wavelength range, and a thermal effect of the light in the first predetermined wavelength range is greater than a thermal effect of the light in the second predetermined wavelength range;
wherein the first predetermined wavelength range ranges from 800 nanometers to 1100 nanometers, and the second predetermined wavelength range ranges from 400 nanometers to 650 nanometers;
wherein the light transmittance of the light in the first predetermined wavelength range on the polarizer is less than 40%, and the light transmittance of the light in the second predetermined wavelength range on the polarizer is greater than 80%.

17. The polarizer according to claim 16, wherein
the polarization main layer comprises a first adhesive layer, a polarization function layer, and a substrate layer; the first adhesive layer is located on a side of the polarization function layer, and the substrate layer is located on a side of the polarization function layer away from the first adhesive layer; and
the optical material is dispersed in the first adhesive layer and the substrate layer.

18. The polarizer according to claim 17, wherein
the substrate layer comprises a first sub-substrate layer, a second adhesive layer, and a second sub-substrate layer stacked on the polarization function layer; and
the optical material is dispersed in one or more of the first adhesive layer, the first sub-substrate layer, the second adhesive layer, and the second sub-substrate layer.

19. The polarizer according to claim 16, wherein
the optical material comprises an absorption function to the light in the first predetermined wavelength range; the optical material is selected from at least one of silicon-substituted xanthene organic matter and triarylmethane dye; and
the optical material is selected from nanometer oxide particles, material of the nanometer oxide particles comprises at least one of magnesium oxide, zinc oxide, and titanium dioxide.

20. The polarizer according to claim 16, wherein the polarization main layer comprises at least one film layer with the optical material dispersed in the film layer, and a mass percentage of the optical material in the film layer ranges from 1% to 5%.
